(19) United States
(12) Patent Application Publication
(10) Pub. No.: US 2023/0401431 A1
(43) Pub. Date: Dec. 14, 2023

(54) METHOD AND ELECTRONIC DEVICE FOR RECOVERING DATA USING BI-BRANCH NEURAL NETWORK

(71) Applicant: City University of Hong Kong, Hong Kong (HK)

(72) Inventors: Xiao Peng LI, Shenzhen (CN); Hing Cheung SO, Hong Kong (HK); Maolin WANG, Yuncheng (CN)

(21) Appl. No.: 17/834,941

(22) Filed: Jun. 8, 2022

(51) Int. Cl. G06N 3/04

(52) U.S. Cl. CPC G06N 3/0481

(57) ABSTRACT

A method for performing data recovering operation by an electronic device is provided. The method includes: receiving, by a processor of the electronic device, object data, wherein the object data comprises an incomplete matrix; identifying, by the processor, a plurality of first entries (x_{i,j}) of the incomplete matrix according to the object data; inputting, by the processor, the first entries (x_{i,j}) and a preset maximum loop count (Kₘₐₓ) into an executed analysis model using Bi-Branch Neural Network (BiBNN) Algorithm; and obtaining, by the processor, a plurality of second entries (m_{i,j}) of a recovered complete matrix corresponding to the incomplete matrix from the analysis model, wherein values of the second entries are determined as original values of the first entries of the incomplete matrix, such that incorrect data in the incomplete matrix is recovered.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to data recovery, and in particular, to a method and electronic device for performing data recovering operation on an incomplete matrix by an analysis model using Bi-Branch Neural Network (BiBNN) algorithm.

### BACKGROUND OF THE INVENTION

The task of matrix completion is to recover the unknown entries in an incomplete matrix by making use of low-rank property. It has been widely applied to various fields, such as image inpainting, recommender system, traffic sensing, system identification and multi-label image classification. Numerous algorithms for matrix completion have been proposed, which can be classified into two categories: linear and nonlinear models.

The linear model is the precursor and mainstay since it provides the basic theories that the missing entries of the incomplete matrix could be exactly restored with high probability under certain conditions. In accordance with the linear model, matrix completion is formulated as a rank minimization problem subject to the recovered entries equal to the known elements in the observation set. Since minimizing rank is an NP-hard problem, practical methods try to handle its substitute. One efficient strategy is to convert the rank function as a constraint and then tackle the resultant problem. The representative methods involve singular value projection (SVP), normalized iterative hard thresholding (NIHT) and alternating projection (AP). Another approach is to use nuclear norm instead of the rank function including singular value thresholding (SVT), accelerated proximal gradient (APG) and fixed-point continuation (FPC). However, these two strategies require computing singular value decomposition, resulting in high computational complexity.

Despite the fact that the linear model provides basic theories ensuring missing entry recovery with high probability, it has an obvious limitation that latent factors are restricted in the linear subspace, resulting in a small feasible region.

In another aspect, the superiority of the nonlinear model over the linear one has been demonstrated in emotion recognition, image inpainting, collaborative filtering and multi-label and multi-class classification.

Therefore, there is a need for studying a matrix completion using nonlinear model, so as to improve the efficiency of matrix completion in foregoing applications.

### SUMMARY OF THE INVENTION

Therefore, a nonlinear model using neural network is provided since the activation function is able to represent the nonlinear relationship. In this patent, a novel and interpretable neural network is devised for matrix completion. Different from conventional neural networks whose structure is created by empirical design, the proposed version is devised via unfolding the matrix factorization formulation. Specifically, the two factors decomposed by matrix factorization construct the two branches of the developed neural network, named as bi-branch neural network (BiBNN). The row and column indices of each entry are considered as the input of the BiBNN, while its output is the estimated value of the entry. The training procedure aims to minimize the fitting error between all observed entries and their predicted values, and then the unknown entries are estimated by inputting their coordinates into the trained network. Experimental results demonstrate that the BiBNN is superior to the existing linear and nonlinear models in processing synthetic data, image inpainting, and recommender system.

In accordance to one aspect of the present invention, a computer-implemented method for performing data recovering operation by an electronic device is provided. The method includes: receiving, by a processor of the electronic device, object data, wherein the object data comprises an incomplete matrix; identifying, by the processor, a plurality of first entries (x_{i,j}) of the incomplete matrix according to the object data; inputting, by the processor, the first entries (x_{i,j}) and a preset maximum loop count (Kₘₐₓ) into an executed analysis model using Bi-Branch Neural Network (BiBNN) Algorithm; and obtaining, by the processor, a plurality of second entries (m_{i,j}) of a recovered complete matrix corresponding to the incomplete matrix from the analysis model, wherein values of the second entries are determined as original values of the first entries of the incomplete matrix, such that incorrect data in the incomplete matrix is recovered.

In accordance to another aspect of the present invention, a computer-implemented method for determining one or more recommendation items from one or more items for one or more user by an electronic device is provided. The method includes: receiving, by a processor of the electronic device, object data, wherein the object data comprises a matrix, wherein rows of the matrix correspond to user IDs of the users respectively, columns of the matrix correspond to item IDs of items respectively, and each entry of the matrix indicates a rating related to corresponding item ID and corresponding user ID; identifying, by the processor, values of first entries (x_{i,j}) of the matrix according to the object data; inputting, by the processor, the entries (x_{i,j}) and a preset maximum loop count (Kₘₐₓ) into an executed analysis model using Bi-Branch Neural Network (BiBNN) Algorithm; obtaining, by the processor, a plurality of second entries (m_{i,j}) of from the analysis model, wherein values of the second entries are determined as original ratings of the matrix, such that unknown ratings of the part of the first entries are predicted; and regarding each user ID, selecting one or more item IDs having ratings higher than a rating threshold, so as to determine one or more recommendation items corresponding to the selected item IDs for user corresponding to each user ID.

In accordance to another aspect of the present invention, an electronic device is provided, and the electronic device comprises a processor configured to execute machine instructions to implement the method described above.

### BRIEF DESCRIPTION OF THE DRAWINGS

Embodiments of the invention are described in more details hereinafter with reference to the drawings, in which:

FIG. 1 depicts a block diagram illustrating an electronic device a in accordance with one embodiment of the present invention;

FIG. 2 depicts a schematic diagram illustrating data recovery operation performed by the analysis model;

FIG. 3 depicts a flowchart of a data recovery method using BiBNN algorithm implemented by the electronic device;

FIG. 4 depicts a flowchart of the BiBNN algorithm;

FIG. 5 depicts a schematic diagram illustrating the architecture of the BiBNN;

FIG. 6 depicts a schematic diagram illustrating the further architecture of the BiBNN;

FIG. 7 depicts a further flowchart of the BiBNN algorithm;

FIG. 8 depicts a schematic diagram illustrating a recommendation system in accordance with another embodiment of the present invention; and

FIG. 9 depicts a flowchart of the recommendation system using the BiBNN algorithm.

### DETAILED DESCRIPTION

In the following description, a method and an electronic device configured to execute the same for performing data recovery and predicting recommendation items by using BiBNN algorithm and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

This invention is a mathematical formulation unfolding algorithmic framework which unrolls matrix factorization formulation to construct neural network architecture. Furthermore, the application of the proposed neural network to image inpainting and recommender system is evidenced. Compared with the existing neural network based schemes, the proposed method is interpretable, ensuring obtaining a locally optimal solution. Besides, its superiority over state-of-the-art approaches has been verified in terms of recovery accuracy. The novel features and claims of the invention are described as follows.

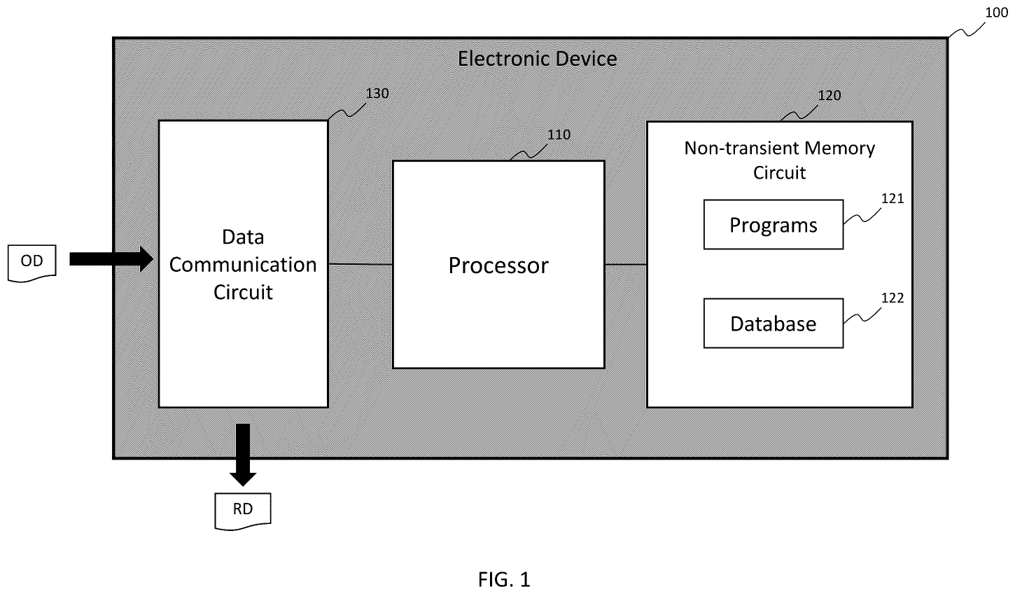

Referring to FIG. 1 in the following description. In accordance with various embodiments of the present invention, provided is an electronic device 100 that includes a processor 110, a non-transient memory circuit 120 and a data communication circuit 130.

The non-transient memory circuit 120 is configured to store machine instructions 121 and to host the database 122. The database 122 may be used to store object data OD, and/or result data RD. The data communication circuit 130 is configured to establish the network connection(s) for receiving the object data OD, and the network connection(s) can be wired or wireless data communication connection(s). Furthermore, the data communication circuit 130 is configured to establish a further network connection for sending the result data RD. The processor 110 executes the machine instructions 121 to implement methods provided by the presented disclosure.

The object data include an “incomplete” matrix, and the dimensions of the incomplete matrix is m×n. Some of data (entries) in a matrix, by interruption of any kind, are lost/unknown (e.g., missing entries) or are determined as not having the original values, as such the matrix is called as an “incomplete matrix”. A complete matrix means that all entries in the matrix are determined as authentic (or not missing) or are determined as having the original values.

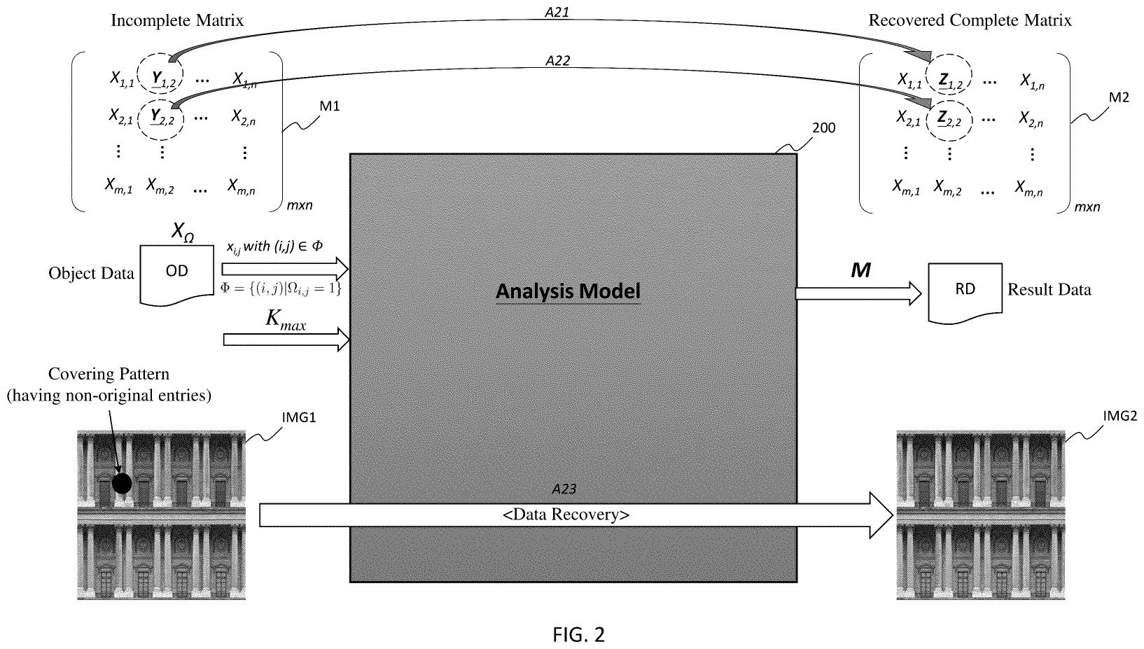

Referring to FIG. 2 in the following description. The incomplete matrix M1 has observed entries (labeled by “X”) and missing entries (labeled by “Y”). The value of each observed entries is known or determined as authentic (being the original value of the desired complete matrix). The value of each missing entries is unknown or determined as not-authentic.

In accordance to one embodiment, the processor 110 executes the analysis model 200 for performing data recovery by analyzing the input data using the BiBNN algorithm. Let X_{Ω}∈ [symbol] be an observed matrix with missing entries. The input data includes the binary values (X_{Ω}) and positions/indexes (i,j) of the observed entries (x_{i,j}) of a binary matrix (Ω) of the incomplete matrix identified from the object data OD, and a preset maximum loop count Kₘₐₓ, wherein x_{i,j} is with (i,j)∈Φ. x_{i,j} is the entry of X at i^{th} row and j^{th} column. The preset maximum loop count Kₘₐₓ is used for limiting the number of the iterative calculations (calculation loop) performed by the Analysis model (BiBNN).

The analysis model 200 generates a recovered complete matrix M according to the input data by using the BiBNN algorithm provided by present disclosure. For example, as illustrated by arrow A21 and A22, the values of missing entries Y_{1,2} and Y_{2,2} of the incomplete matrix M1 is recovered, such that the missing entries Y_{1,2} and Y_{2,2} are recovered as entries Z_{1,2} and Z_{2,2}, and the incomplete matrix M1 is transformed to the recovered complete matrix M2. Then, the processor 110 generates the result data RD having the recovered complete matrix M. The generated result data RD may have auxiliary information related to the object data RD.

For example, for image inpainting, assuming that the interrupted/damaged image IMG1 is received by the processor 110 as the object data OD, wherein a covering pattern is on the image IMG1, the processor 110 determines that the color information of pixels (e.g., missing entries) of the image IMG1 under the covering pattern is missing. The entries other than the missing entries are determined as observed entries (x_{i,j}), and the binary values (X_{Ω}) and positions/indexes (i,j) of the observed entries (x_{i,j}) of the incomplete matrix are confirmed by the processor 110. Then, the observed entries (x_{i,j}) of the image IMG1 is inputted with the preset maximum loop count Kₘₐₓ into the analysis model 200 to recover the image IMG1 to the image IMG2. As illustrated by arrow A23, the color information (values of pixels) corresponding the missing entries of the image IMG1 is recovered as shown by the image IMG2 in the FIG. 2.

X_{Ω} indicates that X projects on the binary matrix Ω comprised of 0 and 1, which corresponds to unobserved and observed elements respectively as the equation (1) presented below.

$${( {X}_{Ω} )}_{i , j} = \{ \begin{matrix}{x}_{i , j} , & if {Ω}_{i , j} = 1 \\ 0 , & otherwise\end{matrix} . \qquad ( 1 )$$

where (X_{Ω})_{i,j} is the (i,j) entry of X_{Ω}. Conceptually, matrix completion is formulated as a rank minimization problem like the equation (2) below:

$${min}_{M} rank ( M ) s . t . {X}_{Ω} = {M}_{Ω} , \qquad ( 2 )$$

That is, matrix completion aims to seek M∈ [symbol] with the minimum rank under the condition when the elements of the restored and observed matrices in the observation set are equal. Unfortunately, equation (2) is a NP-hard problem since the rank function is both nonconvex and discrete. An “NP-Hard problem” takes exponential time to solve because there is no known algorithm that can solve it in polynomial time. A feasible strategy is to substitute the rank function with nuclear norm, corresponding to the following optimization problem as the equation (3) presented below:

$${min}_{M} {‖ M ‖}_{*} s . t . {X}_{Ω} = {M}_{Ω} \qquad ( 3 )$$

where ∥M∥_{*} is the nuclear norm which equals the sum of all singular values of M. Since singular value decomposition (SVD) is performed in each iteration to solve equation (3), the “computational complexity” for solving the equation (3) via SVD is high, especially for big matrices.

The computational complexity is to compare algorithms on the basis of time. This is usually done by calculating the number of steps that the algorithm has to execute for a given set of data and how the number of steps changes when we change the size of the data to be processed. The space complexity is to analyze the variation of space needed to execute a particular algorithm when the amount of data to be processed through the algorithm is varied. As algorithms are programs that perform just a computation, and not other things computers often do such as networking tasks or user input and output, computational complexity analysis allows us to measure how fast a program is when it performs computations, while space complexity indicates how much memory space a program takes up. When we compare two algorithms, if their performance are the same, the one with low complexity is better.

Another prevailing method is to exploit matrix factorization technique which decomposes the objective matrix M into two small-size matrices using the prior rank information, leading to the equation (4) below.

$${min}_{U , V} {‖ {( {UV}^{T} )}_{Ω} - {X}_{Ω} ‖}_{F}^{2} \qquad ( 4 )$$

where (⋅)^{T} signifies the transpose operator, ∥⋅∥_{F} denotes the Frobenius norm, U∈ [symbol] ^{m×r} and V∈ [symbol] . Herein, r is the rank of the objective matrix. For the situation of unknown rank, a strategy to estimate its value is provided, which will be introduced later. Since equation (4) avoids computing SVD, the methods to handle equation (4) have much lower computational complexity than those for equation (3). After seeking U and V, the target matrix can be determined as M=UV^{T}.

It is worth mentioning that a two-stream neural network has been developed for nonlinear matrix completion, termed as neural matrix completion (NMC). Its architecture is designed based on the following equation (5) below.

m_{i,j}=f(rᵢ^{T},cⱼ) (5)

where rᵢ^{T}∈ [symbol] and cⱼ∈ [symbol] represent the ith row and jth column of recovered matrix M, respectively. Specifically, rᵢ and cⱼ are the inputs of the two branches of NMC, and the outputs of two streams are uᵢ∈ [symbol] and vⱼ∈ [symbol] respectively. The neural structure of two branches consists of several fully-connected layers. Furthermore, the output of NMC neural network is m_{i,j}, calculated by the equation (6) below.

$${m}_{i , j} = \frac{{u}_{i}^{T} {υ}_{j}}{{‖ {u}_{i} ‖}_{2} {‖ {υ}_{j} ‖}_{2}} \qquad ( 6 )$$

where ∥⋅∥₂ denotes the [symbol] -norm. All observed entries x_{i,j} with Ω_{i,j}=1 are treated as the training data to the neural network, and then x_{i,j} with Ω_{i,j}=0 is predicted by the trained neural network.

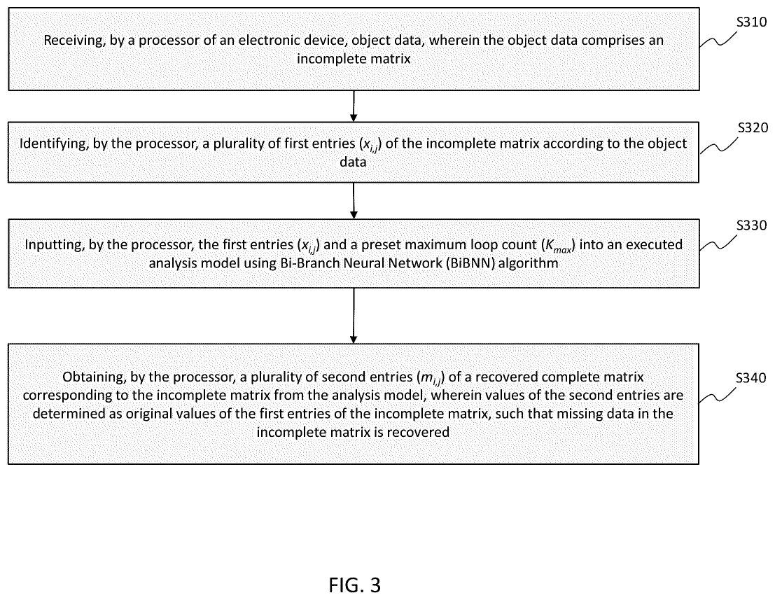

Referring to FIG. 3 in the following description. In step S310, the processor 110 receives object data, wherein the object data comprises an incomplete matrix. Next, in step S320, the processor 110 identifies a plurality of first entries (x_{i,j}) of the incomplete matrix according to the object data. Next, in step S330, the processor 110 inputs the first entries (x_{i,j}) and a preset maximum loop count (Kₘₐₓ) into an executed analysis model using Bi-Branch Neural Network (BiBNN) algorithm. Next, in step S340, the processor 110 obtains a plurality of second entries (m_{i,j}) of a recovered complete matrix corresponding to the incomplete matrix from the analysis model 200, wherein values of the second entries are determined as original values of the first entries of the incomplete matrix, such that missing data in the incomplete matrix is recovered.

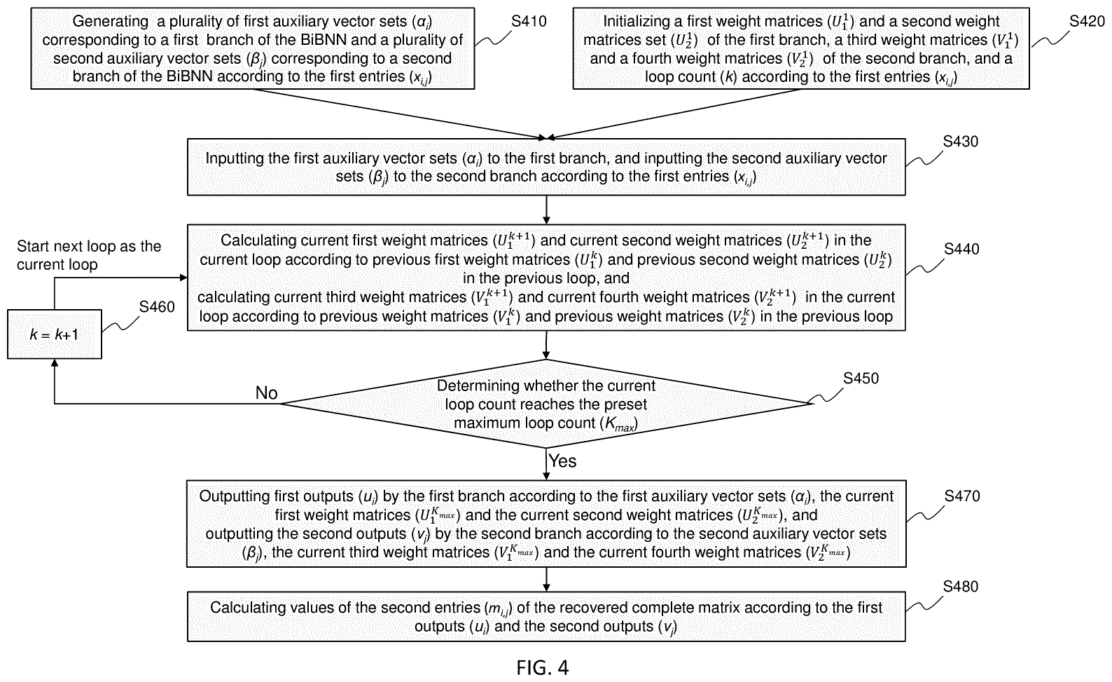

In more detail, the operation of the analysis model using BiBNN executed by the processor 110 is described by FIG. 4. In step S410, the processor 110 generates a plurality of first auxiliary vector sets (αᵢ) corresponding to a first branch of the BiBNN and a plurality of second auxiliary vector sets (βⱼ) corresponding to a second branch of the BiBNN according to the first entries (x_{i,j}).

Furthermore, in step S420, the processor 110 initializes a first weight matrices (U₁¹) and a second weight matrices set (U₂¹) of the first branch, a third weight matrices (V₁¹) and a fourth weight matrices (V₂¹) of the second branch, and a loop count (k) (e.g., k is set to 1) according to the first entries (x_{i,j}).

Next, in step S430, the processor 110 generates and inputting the first auxiliary vector sets (αᵢ) to the first branch, and inputting the second auxiliary vector sets (βⱼ) to the second branch according to the first entries (x_{i,j}).

Next, in step S440, the processor 110 calculates current first weight matrices (U₁^{k+1}) and current second weight matrices (U₂^{k+1}) in the current loop according to previous first weight matrices (U₁^{k}) and previous second weight matrices (U₂^{k}) in the previous loop, and calculates current third weight matrices (V₁^{k+1}) and current fourth weight matrices (V₂^{k+1}) in the current loop according to previous weight matrices (V₁^{k}) and previous weight matrices (V₂^{k}) in the previous loop.

Next, in step S450, the processor 110 determines whether the current loop count reaches the preset maximum loop count (Kₘₐₓ). If the current loop count does not reach the preset maximum loop count (Kₘₐₓ), continue to step S460, the processor 110 increase the loop count by 1 (k=k+1), and starts next calculation loop (e.g., continues to step S440 with k=k+1) as the new current loop.

Otherwise, if the current loop count reaches the preset maximum loop count (e.g., k=Kₘₐₓ), continue to step S470, the processor 110 outputs the first outputs (uᵢ) by the first branch according to the first auxiliary vector sets (αᵢ), the current first weight matrices (U₁^{Kmax}) and the current second weight matrices (U₂^{Kmax}), and outputting the second outputs (vⱼ) by the second branch according to the second auxiliary vector sets (βⱼ), the current third weight matrices (V₁^{Kmax}) and the current fourth weight matrices (V₂^{Kmax}).

Next, in step S480, the processor 110 calculates the values of the second entries (m_{i,j}) of the recovered complete matrix according to the first outputs (ui) and the second outputs (vⱼ). The second entries (m_{i,j}) of the recovered complete matrix are calculated by m_{i,j}=uᵢ^{T}vⱼ in the output layer of BiBNN.

In other words, the observed entries x_{i,j} are inputted into BiBNN to train the BiBNN. Then, after the BiBNN is trained, by inputting (coordinates of the target entry) first auxiliary vector sets (αᵢ) and the second auxiliary vector sets (βⱼ) to the trained BiBNN, the value of the corresponding predicted entry m_{i,j} is obtained/outputted from the BiBNN, such that each of the entire entries (including known or unknown entries) of the recovered matrix can be determined by the outputted m_{i,j}.

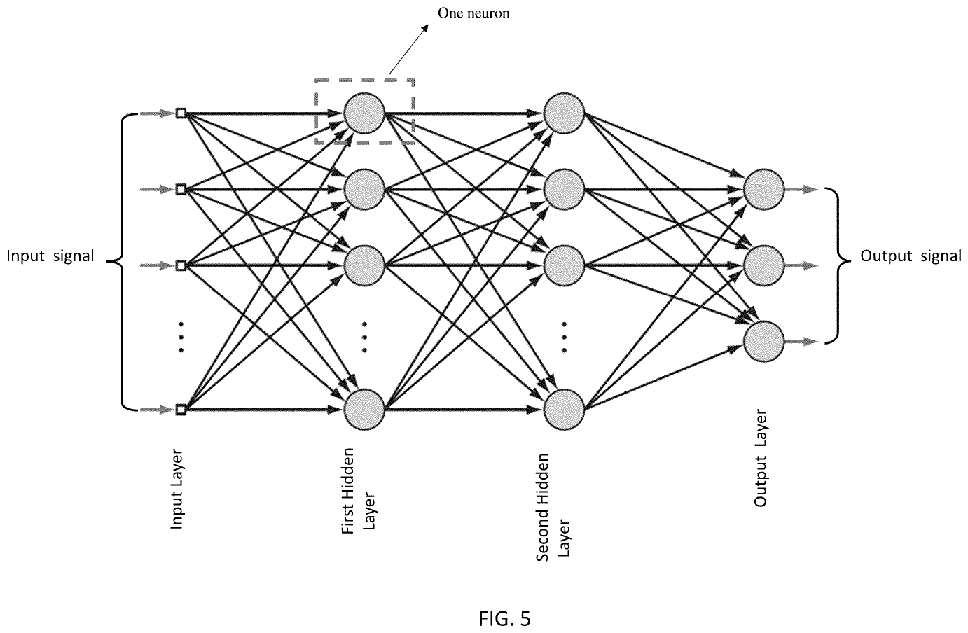

As illustrated by FIG. 5, the neural network used by analysis model 200 is a four-layer fully connected neural network.

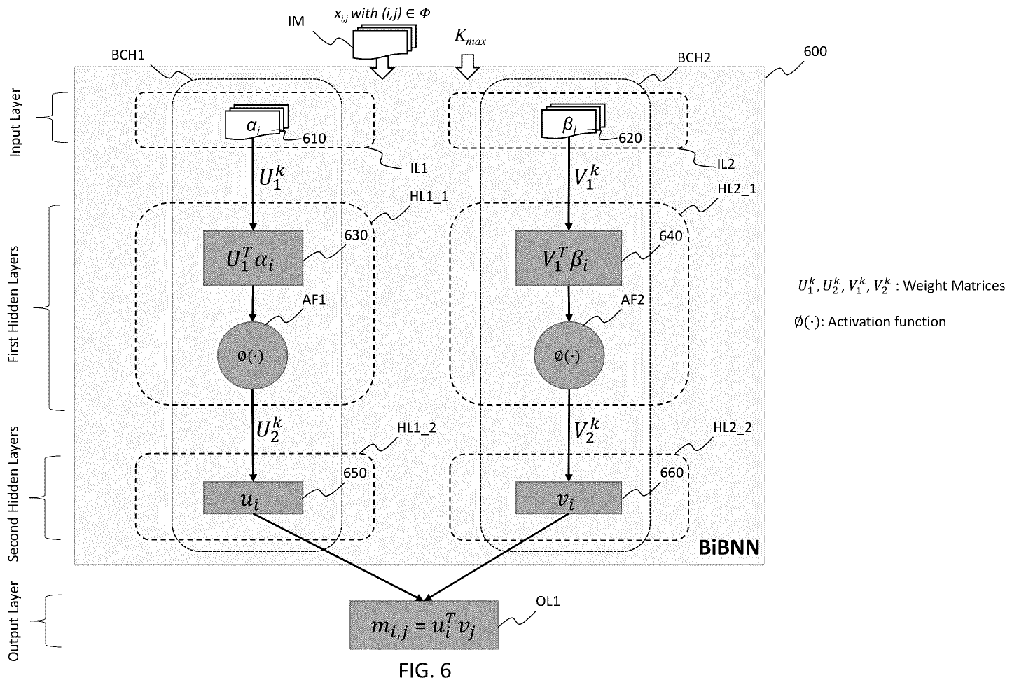

More specifically, referring to FIG. 6, the architecture of the BiBNN 600 comprises the first branch BCH1, the second branch BCH2 and an output layer OL1.

The first branch BCH1 includes an input layer IL1, a first hidden layer HL1_1 and a second hidden layer HL1_2, and the second branch BCH2 includes a further input layer IL2, a further first hidden layer HL2_1 and a further second hidden layer HL2_2.

The first hidden layer HL1_1 is connected from the input layer IL1, the second hidden layer HL1_2 is connected from the first hidden layer HL1_1, the further first hidden layer HL2_1 is connected from the further input layer IL2, the further second hidden layer HL2_2 is connected from the further first hidden layer HL2_1, and the output layer OL1 is connected from the second hidden layer HL1_2 and the further second hidden layer HL2_2.

The first weight matrices (U₁^{k+1}) are calculated between the input layer IL1 and the first hidden layer HL1_1, the second weight matrices (U₂^{k+1}) are calculated between the first hidden layer HL1_1 and the second hidden layer HL1_2, the third weight matrices (V₁^{k+1}) are calculated between the further input layer IL2 and the further first hidden layer HL2_1, the fourth weight matrices (V₂^{k+1}) are calculated between the further first hidden layer HL2_1 and the further second hidden layer HL2_2.

The first hidden layer HL1_1 includes first fully-connected layer 630 and a first activation function layer AF1, wherein the first fully-connected layer 630 output a first calculation result (U₁^{T}αᵢ) according to the first weight matrices (U₁^{k+1}) and the first auxiliary vector sets (αᵢ) 610. The output of first activation function layer is ϕ(U₁^{T}αᵢ), where ϕ( ) is the activation function. The second hidden layer HL1_2 includes a second fully-connected layer 650, wherein the second fully-connected layer 650 output the first outputs (uᵢ). The input of the second fully-connected layer 650 is ϕ(U₁^{T}αᵢ), and the first output is U₂^{T}ϕ(U₁^{T}αᵢ). The further first hidden layer HL2_1 includes a further first fully-connected layer 640 and a further first activation function layer AF2, wherein the further first fully-connected layer 640 output a further first calculation result (V₁^{T}βᵢ) according to the third weight matrices (V₁^{k+1}) and the second auxiliary vector sets (βⱼ) 620. The output of the further first activation function layer is ϕ(V₁^{T}βᵢ), where ϕ( ) is the activation function. The further second hidden layer HL2_2 includes a further second fully-connected layer 660, wherein the further second fully-connected layer 660 output the second outputs (vⱼ). The input of the second fully-connected layer 650 is ϕ(U₁^{T}αᵢ), and the first output is U₂^{T}ϕ(U₁^{T}αᵢ).

The first outputs (uᵢ) and the second outputs (vⱼ) are inputted into the output layer OL1 to calculate the second entries (m_{i,j}) of the recovered complete matrix. The activation function is, for example, selected as ELU (Exponential Linear Unit). Other activation function can be used, such as Rectified Linear Activation (ReLU), Logistic (Sigmoid), Hyperbolic Tangent (Tanh). However, the ELU generates better performance than the others.

The detail of the equations of the BiBNN are described below.

To derive the structure of the BiBNN, the equation (4) us rewritten as the equation (7) below.

$${min}_{U , V} {\sum }_{( i , j )} {( {( U {V}^{T} )}_{i , j} - {x}_{i , j} )}^{2} s . t . {Ω}_{i j} = 1. \qquad ( 7 )$$

In accordance with the matrix product, the (i, j) entry of UV^{T} is equal to the product between the ith row of U and jth row of V. By the representation of m_{i,j}=uᵢ^{T}vⱼ, equation (7) is rewritten as the equation (8) below.

$${min}_{{u}_{i} , {υ}_{j}} {\sum }_{( i , j )} {( {m}_{i , j} - {x}_{i , j} )}^{2} s . t . {m}_{i , j} = {u}_{i}^{T} {v}_{j} , {Ω}_{i , j} = 1. \qquad ( 8 )$$

To clearly describe the network structure by making use of mathematical representation, two auxiliary parameters (vector sets), namely, α∈ [symbol] and β∈ [symbol] are introduced. Given m_{i,j}, only the ith and jth entries of α and β are equal to 1, while the other elements are set to 0, that is, α and β indicate the location of m_{i,j} in M. Thereby, m_{i,j} can be formulated as equation (9) below.

m_{i,j}=(α^{T}U)(V^{T}β) (9)

Then, equation (9) is plugged into equation (8) to obtain equation (10) below.

$$\begin{matrix}{min}_{U , V} {\sum }_{( i , j )} {( ( {α}^{T} U ) ( {V}^{T} β ) - {x}_{i , j} )}^{2} \\ \begin{matrix}s . t . {α}_{l} = \{ \begin{matrix}1 , & if l = i \\ 0 , & otherwise .\end{matrix} , & {β}_{l} = \{ \begin{matrix}1 , & if l = j \\ 0 , & otherwise .\end{matrix} , & {Ω}_{i , j} = 1\end{matrix}\end{matrix} . \qquad ( 10 )$$

Now, equation (10) is unfolded to construct a one-hidden-layer BiBNN for linear matrix completion and then improve it for the nonlinear model. For the structure of the linear neural network, α^{T}U and V^{T}β are considered as the two branches of the BiBNN where α and β are inputs, while the branch outputs are set as uᵢ=U^{T}α and vⱼ=V^{T}β. Furthermore, the output of BiBNN is arranged as m_{i,j}=uᵢ^{T}vⱼ, and the corresponding fitting target is the observed entries x_{i,j}.

In accordance with computation in the fully-connected neural networks, U and V can be deemed as the weight matrices between the input and hidden layers. It is worth mentioning that the weight between the hidden and output layers is a constant, namely, 1, due to m_{i,j}=uᵢ^{T}vⱼ. Thereby, training the BiBNN is equivalent to searching for U and V to minimize (4). Upon the convergence of the BiBNN, a group of U and V can be sought, which attains a local minimum of (4). as the problem is nonconvex.

To attain the nonlinear property, U and V are further decomposed, resulting in equation (11) below.

U=U₁ . . . Uₗ . . . U_{L},

V=V₁ . . . Vₗ . . . V_{L} (11)

where Uₗ∈ [symbol] and Vₗ∈ [symbol] for l∈[1, L] with m₁=m, n₁=n and m_{L+1}=n_{L+1}=r. Based on this deep factorization, equation (10) is rewritten as equation (12) below.

$$\begin{matrix}{min}_{{U}_{l ;} {V}_{l}} {\sum }_{( i , j )} {( ( ϕ ( … ϕ ( {α}^{T} {U}_{1} ) … {U}_{L - 1} ) {U}_{L} ) {( ϕ ( … ϕ ( {β}^{T} {V}_{1} ) … {V}_{L - 1} ) {V}_{L} )}^{T} - {x}_{i , j} )}^{2} \\ \begin{matrix}s . t . {α}_{l} = \{ \begin{matrix}1 , & if l = i \\ 0 , & otherwise .\end{matrix} , & {β}_{l} = \{ \begin{matrix}1 , & if l = j \\ 0 , & otherwise .\end{matrix} , & {Ω}_{i , j} = 1\end{matrix}\end{matrix} , \qquad ( 12 )$$

where ϕ(⋅) is the nonlinear activation function, e.g., hyperbolic tangent (Tanh) and Exponential Linear Unit (ELU). Apparently, the nonlinear property of the proposed neural network is obtained using the activation function Similar to the linear BiBNN, the inputs of the nonlinear BiBNN are α and β, while the outputs of two branches are arranged as ϕ( . . . ϕ(α^{T}U₁) . . . U_{L-1})U_{L} and ϕ( . . . ϕ(β^{T}V₁) . . . V_{L-1})V_{L}. Besides, ϕ( . . . ϕ(α^{T}U₁) . . . Uₗ) and ϕ( . . . ϕ(β^{T}V₁) . . . Vₗ) are the outputs of the l^{th} hidden layer including the activation function. Note that the last hidden layer does not involve the activation function. l can be an integer more or equal to 2.

Since the output is m_{1,2}, α and β are set as [1, 0, . . . , 0] and [0, 1, . . . 0], which result in u₁ and v₂ exporting from the last hidden layer of the two branches.

Convergence Analysis. For concise expression, the convergence property is analyzed based on a two-hidden-layer BiBNN. It is worth mentioning that the analysis is applicable for BiBNN with more than two hidden layers.

According to the derivation of equation (12), equation (12) is equivalent to equation (13) below.

$$= \begin{matrix}{min}_{{U}_{1} , {U}_{2} , {V}_{1} , {V}_{2}} {‖ {( ( ϕ ( {U}_{1} ) {U}_{2} ) {( ϕ ( {V}_{1} ) {V}_{2} )}^{T} )}_{Ω} - {X}_{Ω} ‖}_{F}^{2} \\ {min}_{{U}_{1} , {U}_{2} , {V}_{1} , {V}_{2}} {‖ ( ( ϕ ( {U}_{1} ) {U}_{2} ) {( ϕ ( {V}_{1} ) {V}_{2} )}^{T} - X ) ⊙ Ω ‖}_{F}^{2}\end{matrix} \qquad ( 13 )$$

where ⊙ is the entry-wise product. Besides, the loss function of the objective function is defined as equation (14) below.

[symbol]

(U₁,U₂,V₁,V₂)=∥((ϕ(U₁)U₂)(ϕ(V₁)V₂)^{T}−X)⊙Ω∥_{F}² (14)

The neural network is optimized using the gradient descent method or its variants. Hence, the convergence is analyzed based on gradient descent, leading to the following procedure presented by equations (15) below.

$$\begin{matrix}{U}_{2}^{k + 1} = {U}_{2}^{k} - λ \frac{\partial ℒ ( {U}_{1}^{k} , {U}_{2}^{k} , {V}_{1}^{k} , {V}_{2}^{k} )}{\partial {U}_{2}} \\ = {U}_{2}^{k} - 2 {λϕ ( {U}_{1}^{k} )}^{T} ( ( ( ϕ ( {U}_{1}^{k} ) {U}_{2}^{k} ) {( ϕ ( {V}_{1}^{k} ) {V}_{2}^{k} )}^{T} - X ) ⊙ Ω ) ϕ ( {V}_{1}^{k} ) {V}_{2}^{k}\end{matrix} \qquad ( 15 )$$

$$\begin{matrix}{U}_{1}^{k + 1} = {U}_{1}^{k} - λ \frac{\partial ℒ ( {U}_{1}^{k} , {U}_{2}^{k + 1} , {V}_{1}^{k} , {V}_{2}^{k} )}{\partial {U}_{1}} \\ = {U}_{1}^{k} - 2 λ ( ( ( ( ϕ ( {U}_{1}^{k} ) {U}_{2}^{k + 1} ) {( ϕ ( {V}_{1}^{k} ) {V}_{2}^{k} )}^{T} - X ) ⊙ Ω ) ϕ ( {V}_{1}^{k} ) {{V}_{2}^{k} ( {U}_{2}^{k + 1} )}^{T} ) ⊙ {ϕ}^{′} ( {U}_{1}^{k} )\end{matrix}$$

$$\begin{matrix}{V}_{2}^{k + 1} = {V}_{2}^{k} - λ \frac{\partial ℒ ( {U}_{1}^{k + 1} , {U}_{2}^{k + 1} , {V}_{1}^{k} , {V}_{2}^{k} )}{\partial {V}_{2}} \\ = {V}_{2}^{k} - 2 {λϕ ( {V}_{1}^{k} )}^{T} ( ( ( ϕ ( {U}_{1}^{k + 1} ) {U}_{2}^{k + 1} ) {( ϕ ( {V}_{1}^{k} ) {V}_{2}^{k} )}^{T} - X ) ⊙ Ω ) ϕ ( {U}_{1}^{k + 1} ) {U}_{2}^{k + 1}\end{matrix}$$

$$\begin{matrix}{V}_{1}^{k + 1} = {V}_{1}^{k} - λ \frac{\partial ℒ ( {U}_{1}^{k + 1} , {U}_{2}^{k + 1} , {V}_{1}^{k} , {V}_{2}^{k + 1} )}{\partial {V}_{1}} \\ = {V}_{1}^{k} - 2 λ ( {( ( ( ϕ ( {U}_{1}^{k + 1} ) {U}_{2}^{k + 1} ) {( ϕ ( {V}_{1}^{k} ) {V}_{2}^{k + 1} )}^{T} - X ) ⊙ Ω )}^{T} ϕ ( {U}_{1}^{k + 1} ) {{U}_{2}^{k + 1} ( {V}_{2}^{k + 1} )}^{T} ) ⊙ {ϕ}^{′} ( {V}_{1}^{k} )\end{matrix}$$

where λ>0 is the learning rate parameter and ϕ′(⋅) is the derivative of ϕ(⋅). It is worth mentioning that [symbol] (U₁^{k},U₂^{k},V₁^{k},V₂^{k}) is nonconvex w.r.t U₁, U₂, V₁ and V₂, but it is convex combined with a convex ϕ(⋅) w.r.t. one with fixing the remaining variables. Besides, ϕ(⋅) can be nonconvex as local convexity is adequate to seek a local solution. Since equation (15) leverages gradient descent to update U₂^{k}, U₁^{k}, V₂^{k} and V₁^{k}, the following inequality with an adequately small learning rate is attained as equation (16) presented below.

[symbol]

(U₁^{k},U₂^{k},V₁^{k},V₂^{k})≥ [symbol] (U₁^{k},U₂^{k+1},V₁^{k},V₂^{k})≥ [symbol] (U₁^{k+1},U₂^{k+1},V₁^{k},V₂^{k})≥ [symbol] (U₁^{k+1},U₂^{k+1},V₁^{k},V₂^{k+1})≥(U₁^{k+1},U₂^{k+1},V₁^{k+1},V₂^{k+1}),

That is, [symbol] (U₁^{k},U₂^{k},V₁^{k},V₂^{k}) updated by gradient descent is nonincreasing. In addition, it is easy to know [symbol] (U₁^{k},U₂^{k},V₁^{k},V₂^{k})≥0, indicating that the loss function has a lower bound. Thereby, [symbol] (U₁^{k},U₂^{k},V₁^{k},V₂^{k}) handled by BiBNN is convergent.

Complexity Analysis. First analyze the space complexity. Consider a BiBNN network with two hidden layers whose node numbers are q and r, respectively. The first branch requires storing mq+qr elements, and the entries of the second branch involve nq+qr. Thereby, the total number of entries is (m+n+2r)q, resulting in the space complexity of [symbol] ((m n)q) due to r<<min(m,n). Then the computational complexity is analyzed, including forward and backward propagation. For the forward propagation, the complexity of computing one input is [symbol] ((m+n)(r+1)q). Thereby, the total computational complexity for one epoch is [symbol] ((m²n+mn²)(r+1)qp) where p denotes the percentage of the observed entries. On the other hand, the complexity of the backward propagation can be calculated according to equation (15), specifically [symbol] (mqr+nqr+mnr) for U₂^{k+1}, [symbol] (mqr+nqr+mn(r+q) for U₁^{k+1}, [symbol] (mqr+nqr+mnr) for V₂^{k+1} and [symbol] (mqr+nqr+mn(r+q)) for V₁^{k+1}. As a result, the total computational complexity is [symbol] (mn(r+q)) since [symbol] (mn) dominates [symbol] (mq) and [symbol] (nq).

Rank Selection. For the developed BiBNN, its performance is affected by the selected rank. If the true rank of the objective matrix is unknown, we suggest leveraging the cross-validation method to search for the best rank. First, Ω is divided into two subsets such that Ω₁+Ω₂=Ω and ∥Ω₁∥₁/∥Ω∥₁=0.95. Herein, ∥Ω∥₁ is the [symbol] -norm of Ω, which equals the number of observed entries in the incomplete matrix. Then, X_{Ω}_{₁} is adopted to train BiBNN, while X_{Ω}_{₂} is used to test the neural network. Given a rank, one BiBNN can be trained based on X_{Ω}_{₁}, and the corresponding prediction error is computed using X_{Ω}_{₂}. After trying different ranks, the best rank is determined by the one with the smallest test error.

Data Preprocessing. Since the input data are not directly collected from the observed matrix, preprocessing (forming training data set) is required. Given an incomplete matrix X_{Ω}, all known entries are extracted, as well as compute the corresponding α and β to attain the training dataset. Herein, one entry, associating with its α and β, are considered as a group of training data.

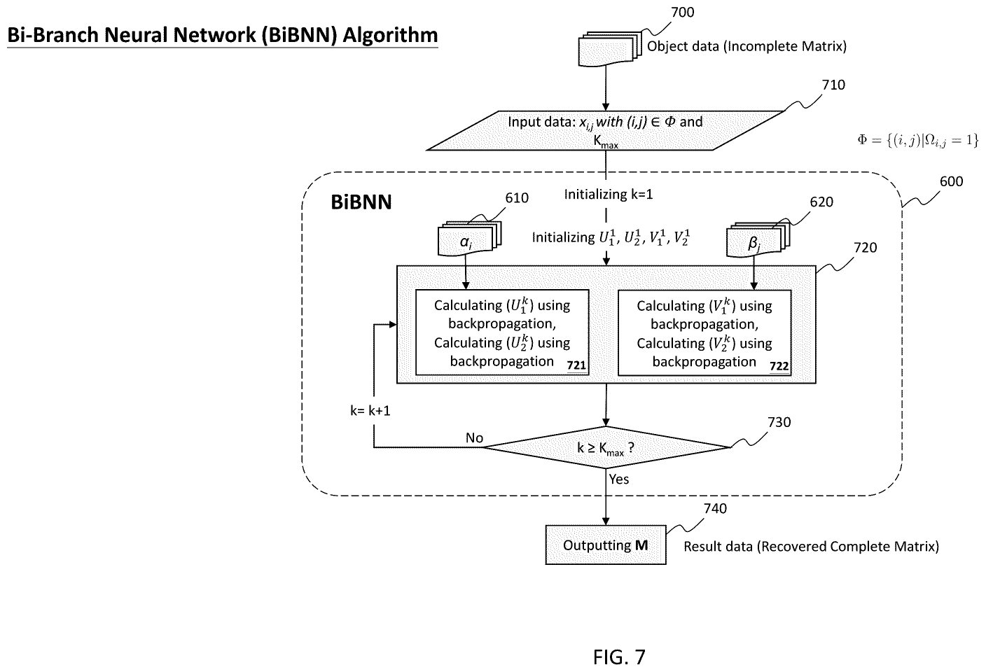

Referring to FIG. 7, the object data 700 is received; in block 710, the first entries x_{i,j} and preset maximum loop count Kₘₐₓ are inputted to the BiBNN 600, wherein loop count k is initialized as 1, weight matrices U₁¹, U₂¹, V₁¹, V₂¹ are initialized, too. Vector sets αᵢ and βⱼ are generated and inputted to the two branches 720 respectively. In the first branch 721, the processor 110 calculates (U₁^{k}) using backpropagation, and calculates (U₂^{k}) using backpropagation; in the second branch 722, the processor 110 calculates (V₁^{k}) using backpropagation, and calculates (V₂^{k}) using backpropagation.

After the calculations performed in block 720 are complete, in block 730, the processor determines whether the loop count k reaches the preset maximum loop count Kₘₐₓ. If the loop count k is smaller than the preset maximum loop count Kₘₐₓ, k=k+1, and then proceed to next calculation loop in block 720; else if the loop count k reaches the preset maximum loop count Kₘₐₓ, proceed to block 740, the BiBNN 600 outputs the recovered complete matrix with calculated second entries m_{i,j}.

In another embodiment, a recommender system can be modeled as an incomplete matrix whose row and column indices represent the user and item identity numbers while the known entries are acquired ratings. The task of matrix completion is to predict the unknown ratings so as to suggest items to users. Furthermore, the latent complete matrix is low-rank as the types of users and items are much less than the numbers of customers and products.

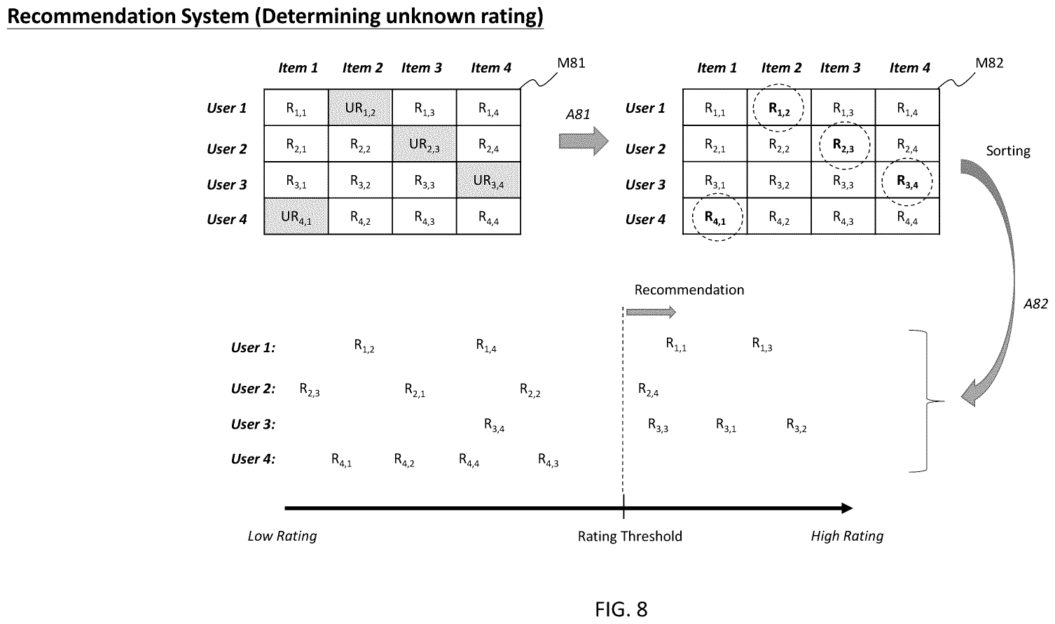

Referring to FIG. 8, for example, assuming that a recommendation system collects customer information, and the recommendation system identifies the ratings of items 1 to items 4 related to User 1 to User 4. However, not all the ratings of items 1 to 4 related to users are known. As illustrated by FIG. 8, the recommendation system further generates corresponding matrix M81 according to the customer information. In the matrix M81, R_{1,1}, R_{1,3}, R_{1,4}, R_{2,1}, R_{2,2}, R_{2,4}, R_{3,1}, R_{3,2}, R_{3,3}, R_{4,2}, R_{4,3}, R_{4,4} indicates the known ratings (R_{1,1} is the rating of item 1 regardign to user 1); and UR_{1,2}, UR_{2,3}, UR_{3,4}, UR_{4,1} indicates the unknown ratings.

As illustrated by arrow A81, the matrix M81 can be recovered as matrix M82 by using the provided matrix completion method. In matrix M82, the unknown entries UR_{1,2}, UR_{2,3}, UR_{3,4}, UR_{4,1} are predicted/determined as entries R_{1,2}, R_{2,3}, R_{3,4}, R_{4,1}. Then, as illustrated by arrow A82, the recommendation system can further sort the ratings of the items for each user. Finally, the recommendation system selects the items have rating higher than the rating threshold as the target items. The recommendation may record these target items corresponding to users and/or promote/recommend these target items to corresponding users. For example, the recommendation system recommend/promote item 1 (corresponding to R_{1,1}) and item 3 (corresponding to R_{1,3}) to user 1 according to the rating R_{1,1} and R_{1,3}.

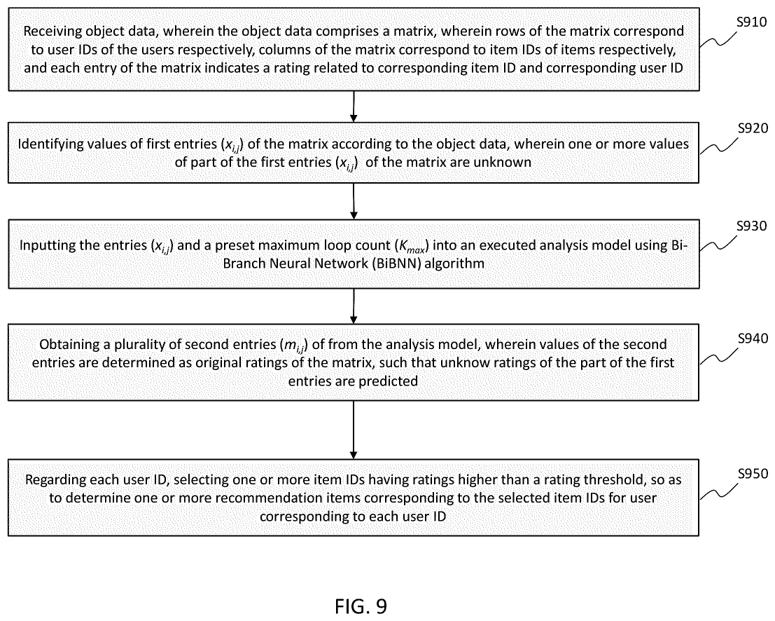

Referring to FIG. 9, in step S910, the processor 110 receives object data, wherein the object data comprises a matrix, wherein rows of the matrix correspond to user IDs of the users respectively, columns of the matrix correspond to item IDs of items respectively, and each entry of the matrix indicates a rating related to corresponding item ID and corresponding user ID. Next, in step S920, the processor 110 identifies values of first entries (x_{i,j}) of the matrix according to the object data, wherein one or more values of part of the first entries (x_{i,j}) of the matrix are unknown.

Next, in step S930, the processor 110 inputs the entries (x_{i,j}) and a preset maximum loop count (Kₘₐₓ) into an executed analysis model using Bi-Branch Neural Network (BiBNN) algorithm. Next, in step S940, the processor 110 obtain a plurality of second entries (m_{i,j}) of from the analysis model, wherein values of the second entries are determined as original ratings of the matrix, such that unknown ratings of the part of the first entries are predicted. Next, in step S950, the processor 110, regarding each user ID, selects one or more item IDs having ratings higher than a rating threshold, so as to determine one or more recommendation items corresponding to the selected item IDs for user corresponding to each user ID.

In other words, the recommendation system can predict ratings of items to which a user didn't build relationship based on the history record containing known ratings of other items related to that user.

The functional units of the apparatuses and the methods in accordance to embodiments disclosed herein may be implemented using computing devices, computer processors, or electronic circuitries including but not limited to application specific integrated circuits (ASIC), field programmable gate arrays (FPGA), and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments include computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units in accordance to various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A computer-implemented method for performing data recovering operation by an electronic device, comprising:
receiving, by a processor of the electronic device, object data, wherein the object data comprises an incomplete matrix;
identifying, by the processor, a plurality of first entries (x_{i,j}) of the incomplete matrix according to the object data;
inputting, by the processor, the first entries (x_{i,j}) and a preset maximum loop count (Kₘₐₓ) into an executed analysis model using Bi-Branch Neural Network (BiBNN) algorithm; and
obtaining, by the processor, a plurality of second entries (m_{i,j}) of a recovered complete matrix corresponding to the incomplete matrix from the analysis model, wherein values of the second entries are determined as original values of the first entries of the incomplete matrix, such that incorrect data in the incomplete matrix is recovered.

2. The method of claim 1, further comprising:
generating a plurality of first auxiliary vector sets (αᵢ) corresponding to a first branch of the BiBNN and a plurality of second auxiliary vector sets (βⱼ) corresponding to a second branch of the BiBNN according to the first entries (x_{i,j});
initializing a first weight matrices (U₁¹) and a second weight matrices (U₂¹) of the first branch, a third weight matrices (V₁¹) and a fourth weight matrices (V₂¹) of the second branch, and a loop count (k) according to the first entries (x_{i,j});
inputting the first auxiliary vector sets (αᵢ) to the first branch, and inputting the second auxiliary vector sets (βⱼ) to the second branch according to the first entries (x_{i,j});
calculating current first weight matrices (U₁^{k+1}) and current second weight matrices (U₂^{k+1}) in the current loop according to previous first weight matrices (U₁^{k}) and previous second weight matrices (U₂^{k}) in the previous loop, and
calculating current third weight matrices (V₁^{k+1}) and current fourth weight matrices (V₂^{k+1}) in the current loop according to previous third weight matrices (V₁^{k}) and previous fourth weight matrices (V₂^{k}) in the previous loop;
determining whether the current loop count reaches the preset maximum loop count (Kₘₐₓ),
wherein if the current loop count does not reach the preset maximum loop count,
wherein if the current loop count reaches the preset maximum loop count, outputting the first outputs (uᵢ) by the first branch according to the first auxiliary vector sets (αᵢ), the current first weight matrices (U₁^{Kmax}) and the current second weight matrices (U₂^{Kmax}), and
outputting the second outputs (vⱼ) by the second branch according to the second auxiliary vector sets (βⱼ), the current third weight matrices (V₁^{Kmax}) and the current fourth weight matrices (V₂^{Kmax}); and
calculating the values of the second entries (m_{i,j}) of the recovered complete matrix according to the first outputs (uᵢ) and the second outputs (vⱼ).

3. The method of claim 1, wherein architecture of the BiBNN comprises the first branch, the second branch and an output layer,
wherein the first branch includes an input layer, a first hidden layer and a second hidden layer, and the second branch includes a further input layer, a further first hidden layer and a further second hidden layer,
wherein the first hidden layer is connected from the input layer, the second hidden layer is connected from the first hidden layer, the further first hidden layer is connected from the further input layer, the further second hidden layer is connected from the further first hidden layer, and the output layer is connected from the second hidden layer and the further second hidden layer,
wherein the first weight matrices (U₁^{k+1}) are calculated between the input layer and the first hidden layer, the second weight matrices (U₂^{k+1}) are calculated between the first hidden layer and the second hidden layer, the third weight matrices (V₁^{k+1}) are calculated between the further input layer and the further first hidden layer, the fourth weight matrices (V₂^{k+1}) are calculated between the further first hidden layer and the further second hidden layer.

4. The method of claim 3, wherein
the first hidden layer includes a first fully-connected layer and a first activation function layer, wherein the first fully-connected layer output a first calculation result (U₁^{T}αᵢ) according to the first weight matrices (U₁^{k+1}) and the first auxiliary vector sets (αᵢ);
the second hidden layer includes a second fully-connected layer, wherein the second fully-connected layer output the first outputs (uᵢ);
the further first hidden layer includes a further first fully-connected layer and a further first activation function layer, wherein the further first fully-connected layer output a further first calculation result (V₁^{T}βᵢ) according to the third weight matrices (V₁^{k+1}) and the second auxiliary vector sets (βⱼ); and
the further second hidden layer includes a further second fully-connected layer, wherein the further second fully-connected layer output the second outputs (vⱼ).

5. The method of claim 1, wherein the second entries (m_{i,j}) of the recovered complete matrix are calculated by the equation below:
m_{i,j}=uᵢ^{T}vⱼ.

6. A computer-implemented method for determining one or more recommendation items from one or more items for one or more user by an electronic device, comprising:
receiving, by a processor of the electronic device, object data, wherein the object data comprises a matrix, wherein rows of the matrix correspond to user IDs of the users respectively, columns of the matrix correspond to item IDs of items respectively, and each entry of the matrix indicates a rating related to corresponding item ID and corresponding user ID;
identifying, by the processor, values of first entries (x_{i,j}) of the matrix according to the object data;
inputting, by the processor, the entries (x_{i,j}) and a preset maximum loop count (Kₘₐₓ) into an executed analysis model using Bi-Branch Neural Network (BiBNN) algorithm;
obtaining, by the processor, a plurality of second entries (m_{i,j}) of from the analysis model, wherein values of the second entries are determined as original ratings of the matrix, such that unknown ratings of the part of the first entries are predicted; and
regarding each user ID, selecting, by the processor, one or more item IDs having ratings higher than a rating threshold, so as to determine one or more recommendation items corresponding to the selected item IDs for user corresponding to each user ID.

7. The method of claim 6, further comprising:
generating a plurality of first auxiliary vector sets (αᵢ) corresponding to a first branch of the BiBNN and a plurality of second auxiliary vector sets (βⱼ) corresponding to a second branch of the BiBNN according to the first entries (x_{i,j});
initializing a first weight matrices (U₁¹) and a second weight matrices (U₂¹) of the first branch, a third weight matrices (V₁¹) and a fourth weight matrices (V₂¹) of the second branch, and a loop count (k) according to the first entries (x_{i,j});
inputting the first auxiliary vector sets (αᵢ) to the first branch, and inputting the second auxiliary vector sets (βⱼ) to the second branch according to the first entries (x_{i,j});
calculating current first weight matrices (U₁^{k+1}) and current second weight matrices (U₂^{k+1}) in the current loop according to previous first weight matrices (U₁^{k}) and previous second weight matrices (U₂^{k}) in the previous loop, and
calculating current third weight matrices (V₁^{k+1}) and current fourth weight matrices (V₂^{k+1}) in the current loop according to previous third weight matrices (V₁^{k}) and previous fourth weight matrices (V₂^{k}) in the previous loop;
determining whether the current loop count reaches the preset maximum loop count (Kₘₐₓ),
wherein if the current loop count does not reach the preset maximum loop count,
wherein if the current loop count reaches the preset maximum loop count, outputting the first outputs (uᵢ) by the first branch according to the first auxiliary vector sets (αᵢ), the current first weight matrices (U₁^{Kmax}) and the current second weight matrices (U₂^{Kmax}), and
outputting the second outputs (vⱼ) by the second branch according to the second auxiliary vector sets (βⱼ), the current third weight matrices (V₁^{Kmax}) and the current fourth weight matrices (V₂^{Kmax}); and
calculating the values of the second entries (m_{i,j}) of the complete matrix according to the first outputs (uᵢ) and the second outputs (vⱼ).

8. The method of claim 6, wherein architecture of the BiBNN comprises the first branch, the second branch and an output layer,
wherein the first branch includes an input layer, a first hidden layer and a second hidden layer, and the second branch includes a further input layer, a further first hidden layer and a further second hidden layer,
wherein the first hidden layer is connected from the input layer, the second hidden layer is connected from the first hidden layer, the further first hidden layer is connected from the further input layer, the further second hidden layer is connected from the further first hidden layer, and the output layer is connected from the second hidden layer and the further second hidden layer,
wherein the first weight matrices (U₁^{k+1}) are calculated between the input layer and the first hidden layer, the second weight matrices (U₂^{k+1}) are calculated between the first hidden layer and the second hidden layer, the third weight matrices (v₁^{k+1}) are calculated between the further input layer and the further first hidden layer, the fourth weight matrices (V₂^{k+1}) are calculated between the further first hidden layer and the further second hidden layer.

9. The method of claim 8, wherein
the first hidden layer includes a first fully-connected layer and a first activation function layer, wherein the first fully-connected layer output a first calculation result (U₁^{T}αᵢ) according to the first weight matrices (U₁^{k+1}) and the first auxiliary vector sets (αᵢ);
the second hidden layer includes a second fully-connected layer, wherein the second fully-connected layer output the first outputs (uᵢ);
the further first hidden layer includes a further first fully-connected layer and a further first activation function layer, wherein the further first fully-connected layer output a further first calculation result (Vᵢ^{T}βᵢ) according to the third weight matrices (V₁^{k+1}) and the second auxiliary vector sets (βⱼ); and
the further second hidden layer includes a further second fully-connected layer, wherein the further second fully-connected layer output the second outputs (vⱼ).

10. The method of claim 6, wherein the second entries (m_{i,j}) of the complete matrix are calculated by the equation below:
m_{i,j}=uᵢ^{T}vⱼ.

11. An electronic device for performing data recovering operation, comprising:
a processor, configured to execute machine instructions to implement a computer-implemented method, the method comprising:
receiving, by a processor of the electronic device, object data, wherein the object data comprises an incomplete matrix;
identifying, by the processor, a plurality of first entries (x_{i,j}) of the incomplete matrix according to the object data,
inputting, by the processor, the first entries (x_{i,j}) and a preset maximum loop count (Kₘₐₓ) into an executed analysis model using Bi-Branch Neural Network (BiBNN) algorithm; and
obtaining, by the processor, a plurality of second entries (m_{i,j}) of a recovered complete matrix corresponding to the incomplete matrix from the analysis model, wherein values of the second entries are determined as original values of the first entries of the incomplete matrix, such that incorrect data in the incomplete matrix is recovered.

12. An electronic device for determining one or more recommendation items for one or more user from one or more items, comprising:
a processor, configured to execute machine instructions to implement a computer-implemented method, the method comprising:
receiving, by a processor of the electronic device, object data, wherein the object data comprises a matrix, wherein rows of the matrix correspond to user IDs of the users respectively, columns of the matrix correspond to item IDs of items respectively, and each entry of the matrix indicates a rating related to corresponding item ID and corresponding user ID;
identifying, by the processor, values of first entries (x_{i,j}) of the matrix according to the object data;
inputting, by the processor, the entries (x_{i,j}) and a preset maximum loop count (Kₘₐₓ) into an executed analysis model using Bi-Branch Neural Network (BiBNN) algorithm;
obtaining, by the processor, a plurality of second entries (m_{i,j}) of from the analysis model, wherein values of the second entries are determined as original ratings of the matrix, such that unknown ratings of the part of the first entries are predicted; and
regarding each user ID, selecting, by the processor, one or more item IDs having ratings higher than a rating threshold, so as to determine one or more recommendation items corresponding to the selected item IDs for user corresponding to each user ID.
